(19) United States
(12) Patent Application Publication
(10) Pub. No.: US 2016/0321366 A1
(43) Pub. Date: Nov. 3, 2016

(54) CONSTRAINED-OR OPERATOR

(71) Applicant: Linkedln Corporation, Mountain View, CA (US)

(72) Inventor: Sriram Sankar, Palo Alto, CA (US)

(21) Appl. No.: 14/711,912

(22) Filed: May 14, 2015

Related U.S. Application Data
(60) Provisional application No. 62/155,283, filed on Apr. 30, 2015.

(51) Int. Cl. G06F 17/30

(52) U.S. Cl. CPC G06F 17/30867; G06F 17/3053

(57) ABSTRACT

In a first example embodiment, a constrained OR operator is received, the constrained OR operator including a plurality of arguments and a value M, M being an integer greater than 1 and less than the number of arguments in the plurality of arguments. Then a set of data in a database is evaluated based on each of the plurality of arguments, producing a plurality of posting lists corresponding to the arguments, each posting list containing a listing of data satisfying a corresponding argument. Data in the set of data that satisfies the constrained OR operator is determined by obtaining an identification of each piece of data that is contained in at least M of the posting lists. Then identifications of each piece of data in the set of data that satisfies the constrained OR operator are returned.

### TECHNICAL FIELD

The present disclosure generally relates to information retrieval and processing. More specifically, the present disclosure relates to methods, systems, and computer program products for a constrained-OR operator.

### BACKGROUND

Retrieval operators are logical operations used in the retrieval of information in a computer system. Common retrieval operators include OR (in which results are retrieved that meet any of the conditions specified by the operator) and AND (in which results are retrieved that meet all of the conditions specified by the operator), although there are many other retrieval operators as well. Data is often stored in a computer database and then indexed for easy and efficient retrieval. One commonly used index format is an inverted index. An inverted index is an index data structure storing a mapping between content. In the case of storing user profiles in a social network, this may include mapping individual terms in user profiles to an identification of user profiles containing the terms. Thus, a search for a particular term, such as “chess,” would yield member identifications for all members whose user profiles contain the words “chess” in the inverted index and would yield a location for the user profile in the database. Of course, the inverted index can also be used to retrieve data based on more complex retrieval operators or combinations thereof.

Typically the inverted index is sorted (e.g., by ranking the entries in alphabetical order by term). Thus, evaluation of a retrieval operator typically involves traversing the sorted inverted index, evaluating each term against a condition, and acting appropriately. This process can utilize a lot of processing power and can cause a search to be slow when the inverted index is quite large, as is often the case in social networks with millions of users. As such, it is desirable to improve the efficiency of the evaluations of retrieval operators, and specifically to improve the efficiency of such evaluations in large inverted indexes.

### DESCRIPTION OF THE DRAWINGS

Some embodiments of the technology are illustrated by way of example and not limitation in the figures of the accompanying drawings.

FIG. 1 is a diagram illustrating operation of an AND operator in accordance with an example embodiment.

FIG. 2 is a diagram illustrating operation of an OR operator in accordance with an example embodiment.

FIG. 3 is a diagram illustrating operation of a constrained OR operator in accordance with an example embodiment.

FIG. 4 is a network diagram depicting a client-server system, within which various example embodiments may be deployed.

FIG. 5 is a block diagram illustrating example modules of the application(s) of FIG. 1.

FIG. 6 is a flow diagram illustrating a method for execution of a constrained OR operator in accordance with an example embodiment.

FIG. 7 is a block diagram illustrating a mobile device, according to an example embodiment.

FIG. 8 is a block diagram of machine in the example form of a computer system within which instructions can be executed for causing the machine to perform any one or more of the methodologies discussed herein.

### DETAILED DESCRIPTION

### Overview

The present disclosure describes, among other things, methods, systems, and computer program products, which individually provide functionality for improving speed and efficiency of storage in a social network service. In the following description, for purposes of explanation, numerous specific details are set forth in order to provide a thorough understanding of the various aspects of different embodiments of the present disclosure. It will be evident, however, to one skilled in the art, that the present disclosure may be practiced without all of the specific details.

In an example embodiment, a new type of retrieval operator is introduced, known as the constrained OR operator, that is optimized for use in large inverted indexes, such as those pertaining to user profiles in a social network environment.

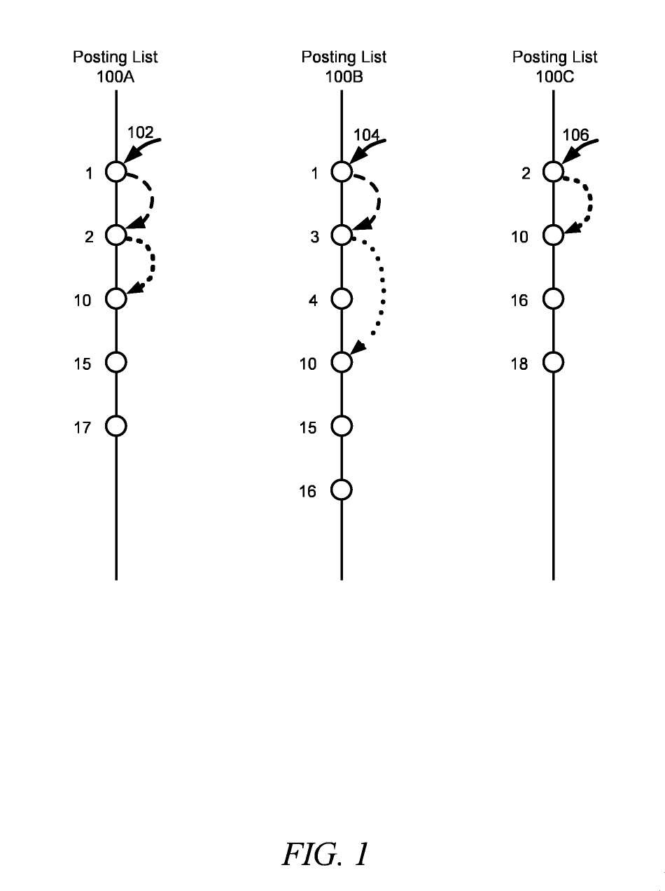

An AND operator may work by creating multiple pointers, one for each of the arguments of the AND operator, and moving them each one by one through a posting list for each argument, evaluating each argument as they move. If no match is found, then the pointer that is at the lowest position is moved ahead and the process is repeated. This is depicted in FIG. 1.

FIG. 1 is a diagram illustrating operation of an AND operator in accordance with an example embodiment. A separate posting list 100A, 100B, 100C is created for each argument of the AND operator. FIG. 1 depicts a case where there are three arguments of the AND operator, and thus there are three posting lists 100A, 100B, 100C. One of ordinary skill in the art will recognize that any number of arguments may be supplied to an AND operator, and thus there may be any number of corresponding posting lists 100A, 100B, 100C.

Each posting list 100A, 100B, 100C contains a listing of retrieved documents that meet the criteria of the corresponding argument. Thus, if the AND operator is (AND residence.state=CA, age=20-29, skill=executive), then posting list 100A may correspond to a list of member identifications (IDs) of members whose profile lists a residence state of California, posting list 100B may correspond to a list of member identifications of members whose profile lists an age of 20-29, and posting list 100C may correspond to a list of member identifications of members whose profile lists a skill of “executive.” The posting lists 100A-100C may be sorted in ascending order.

A pointer 102, 104, 106 is then assigned to each posting list 100A, 100B, 100C. At the beginning, each pointer 102, 104, 106 points to the beginning of the corresponding posting list 100A, 100B, 100C. As the process moves on, each pointer 102, 104, 106 is eventually moved through the corresponding posting list 100A, 100B, 100C.

A “next” operator moves a pointer to the next element in the posting list. An “advance” operator acts to skip the pointer to a particular element in the posting list (as specified by a member ID provided as an argument to the advance operator), assuming that particular element is present; if the element is not present, the advance operator moves the pointer to a first element in the posting list that is after the specified member ID. Both the next and advance operator return a member ID, which can then be used to determine whether a match occurs. Since using the advance operator is more efficient than using the next operator, it is desirable for an implementation to attempt to maximize the number of advance operators that are used while minimizing the number of next operators that are used.

A loop is begun where it is determined if a match exists between all the elements that the pointers are currently pointing to. In the beginning, pointer 102 points to the first element in posting list 100A, which is “1”, indicating that a member ID of “1” satisfied whatever the argument was for posting list 100A (here, a residence state of California). Pointer 104 points to the first element in posting list 100B (“1”), and pointer 106 points to the first element in posting list 100C (“2”). Since these elements do not all match (“1”, “1” and “2”), no match is found yet. Then the pointer to the lowest element value is moved. Here, both pointer 102 and pointer 104 currently point to elements of “1” while pointer 106 points to an element of “2”. Thus, either pointer 102 or pointer 104 can be advanced. For simplicity, assumed that both are moved. Rather than using a next operator, an advance operator may be used with the argument being the highest of the element values currently pointed to (here, “2” from pointer 106). Thus, an advance operator is issued for pointer 102 with the argument “2”. An element of “2”, however, is not present in posting list 100B thus pointer 102 advances to the next element in the posting list 100B that follows “2,” which in this case is “3”. “2” is present, however, in posting list 100A, and thus when pointer 104 is issued the advance operator with the argument “2”, it actually advances to ‘2”. Thus, at this stage, pointer 102 points to “2” in posting list 100A, pointer 104 points to “3” in posting list 100B, and pointer 106 points to “2” in posting list 100C. Thus, there is still no match among the currently pointed to elements (“2” “3” and “2”). This process continues, advancing pointers 102 and 106 to “3” since these pointers currently point to “2”. This advances pointer 102 to “10” and pointer 106 to “10”.

There still is no match (“10”, “4”, and “10”) and thus pointer 104 is advanced to “10”, which is present in posting list 100B. Thus pointer 102 points to “10” in posting list 100A, pointer 104 points to “10” in posting list 100B, and pointer 106 points to “10” in posting list 100C (notably skipping over “4,” which is present in posting list 100B). At this point, a match exists because all three pointers 102, 104, 106 point to an element “10” in their respective posting lists 100A, 100B, and 100C.

An OR operator may similarly work by creating multiple pointers, one for each of the arguments of the OR operator, and moving them each one by one through a posting list for each argument, evaluating each argument as they move. If any match is identified, then the pointer that is at the lowest position is moved ahead and the process is repeated.

In an example embodiment, a heap is used for the OR operator. A heap is a data structure that can be used to efficiently keep track of (and retrieve) the minimum of a set of numbers. Rather than doing an advance operation, a next operation is applied to pointers. At each stage the resulting elements are placed into a heap. Thus, at the beginning, all pointers point to the first element in each posting list. These elements are then put into a heap. The minimum in the heap is then found, and this minimum represents a match. Then, a next operation is applied to each pointer corresponding to an element that has that minimum value. At this stage, the currently pointed to elements are all placed into a heap and the process repeats.

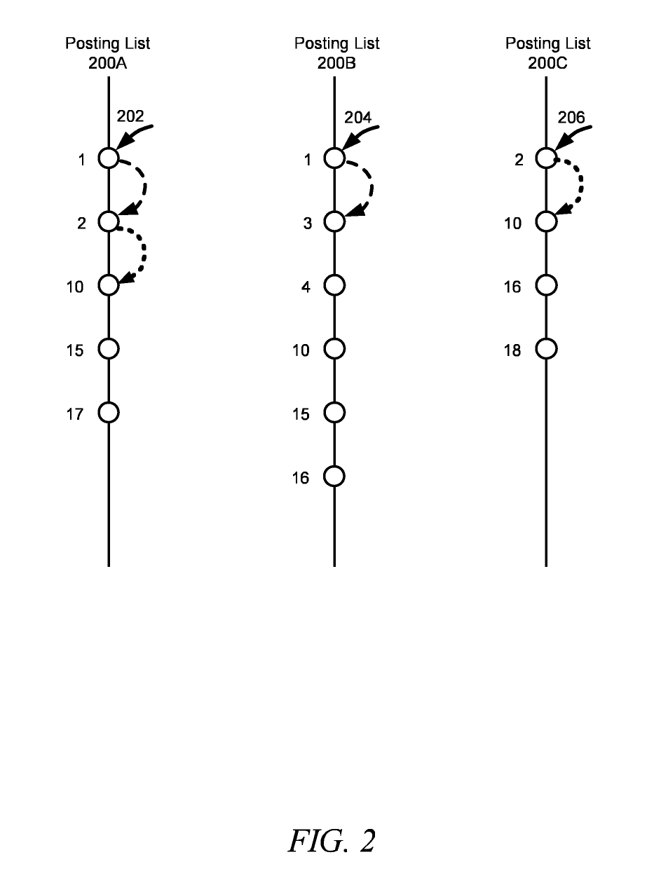

FIG. 2 is a diagram illustrating operation of an OR operator in accordance with an example embodiment. A separate posting list 200A, 200B, 200C is created for each argument of the OR operator. FIG. 2 depicts a case where there are three arguments of the OR operator, and thus there are three posting lists 200A, 200B, 200C. One of ordinary skill in the art will recognize that any number of arguments may be supplied to an OR operator, and thus there may be any number of corresponding posting lists 200A, 200B, 200C.

As described above, at the beginning each of the pointers 202, 204, 206 points to the first element in the respective posting lists 200A, 200B, 200C, and the resulting elements are placed in a heap. Thus at this point the heap contains “1”, “1”, and “2”. The minimum of this heap (“1”) is then obtained and deemed to be a match. Then a next operation is applied to each pointer currently pointing to this minimum element (here pointers 202 and 204). Then the resulting elements currently pointed to by each pointer 202, 204, 206 are placed in a heap (here “2”, “3”, “2”). Once again the minimum element in the heap is determined (“2”) and deemed to be a match. Then each pointer currently pointing to this minimum element (here pointers 202 and 206) is applied a next operation. Once again the resulting elements are placed in a heap (here, “10”, “3”, and “10”). This process continues until the posting lists 200A, 200B, 200C are completely traversed.

As described briefly above, a new operator known as a constrained OR is introduced in an example embodiment. The operands of a constrained OR include any number of arguments as well as a specified constant. For simplicity the specified constant will be referred to as M. The constrained OR is matched if at least M of the specified arguments are matched. In other words, as long as at least M of the arguments produce a match, the constrained OR is considered as fulfilled. As such the constrained OR may be thought of as a retrieval operator that is somewhere between an AND (where all arguments must be matched) and an OR (where only one argument must be matched). Indeed, if M is set to be equal to the number of specified arguments, then the constrained OR operator is essentially an AND. Likewise, if M is set to be equal to 1, then the constrained OR operator is essentially an OR. As such, the constrained OR operator works better when M is set to somewhere between 1 and the number of specified arguments.

Because the OR operator relies on next operations instead of advance operations, an OR operator can be much slower than an AND operation. This is because advance operations allow elements in the posting lists 200A, 200B, 200C to be skipped, while next operations do not. Ordinarily this may be fine if the detection of a lot of matches is desirable. In some instances, however if a different type of operator such as a constrained OR is desired implementing such an operator as an OR followed by constraint checking becomes slow.

This new constrained OR operator can also find specific use in helping advertisers identify users to present advertisements to based on their user profiles in a social network. For example, a car company may wish to identify users with desirable attributes to whom to present their advertisement. This may include, for example, a residence location in a particular desirable area (e.g., California, New York), an age within one or more desirable age ranges (e.g., 20-29 years old, 30-39 years old), and particular skill sets (e.g., executive, software engineer). While such an advertiser may have specific ideas of desirable attributes of users, it is common for the social network to have more categories of attributes than an advertiser really cares about. For example, a social network may collect 20 different categories of attributes for users, but an advertiser may only really care about five of those categories. As such, many advertisers leave conditions of those categories (e.g., the remaining 15) blank, meaning that the advertiser has specified a wild card for these categories.

When a user makes a visit to a web page where an advertisement can be served, an advertisement engine evaluates multiple possible advertising campaigns to identify an advertisement campaign to apply to the user. For example, the advertisement engine can select from among a car company, soda manufacturer, and fast food establishment as to which advertisement to present to the user, but this selection depends on an evaluation of which campaign most closely matches this particular user's attributes.

Turning now to efficient execution of the constrained OR operator, in an example embodiment the constrained OR operator can be implemented as a modified OR operator. Specifically, the OR operator is performed to obtain a series of matches. These matches will be combinations of matches where one argument matched, two arguments matched, three arguments matched, etc. The constrained OR operator can discard any of the OR matches whose number of arguments matched is less than M. Thus, if M is 3, then all matches from the OR operator where one argument matched and all matches from the OR operator where two arguments matched are discarded, and the remaining matches are considered to be the matches for the constrained OR operator. This, however, winds up being as inefficient as a traditional OR operator.

In another example embodiment, the constrained OR operator is split into two parts, one that contains M−1 posting lists, and the other that contains N−M+1 posting lists, where N is the total number of possible posting lists (available arguments). This allows the part that contains N−M+1 to be analyzed. If there isn't at least one match in the N−M+1 part, then there is no need to analyze the M−1 part because even if all arguments in the M−1 part had a match, this still wouldn't be enough to satisfy the requirement of the constrained OR operator that at least M arguments match.

These two parts of the arguments of the constrained OR operator may be known as group I (the N−M+1 part) and group II (the M−1 part). An OR operator can then be applied to group I, and for every match found in group I, an AND operator is applied to that match against group II. The match from group I may be known as the candidate.

In an example embodiment, while the OR operator is applied to group I, not only are all possible candidates retrieved by the number of matches found solely in group I is maintained, so that only that number of matches need to be found in group II. For example, if N is 7 and M is 4, and “1”, “5”, and “10” are determined to be matches in group I, the system could also track how many matches of each of “1”, “5”, and “10” are found in group I. For example, if there is only a single match of “1” and “10” in group I but two matches of “5”, then when the AND operator is applied to the candidate “5” against group II, there is only a need to find two matches as opposed to three matches in order for a successful match for the constrained OR operator to be found.

The number of entities on which the OR operator needs to be applied is greatly reduced by using the constrained OR operator in this manner, which results in fewer computing resources being utilized for such a matching process.

It should be noted that the OR operator and the AND operator may be executed back and forth, with the OR operator producing a candidate from group I and the AND operator then being applied for the candidate against group II; then, regardless of whether a match is found, the OR operator advances to try and produce another candidate to be evaluated.

When an end of a posting list is reached, that list is called “dead”. Dead posting lists may be removed from their respective groups. Additionally, some housekeeping may occur to rearrange the groups for optimal efficiency. For example, it may be desirable to ensure that there are at least two posting lists in group II at any one time. Thus, if the number of posting lists in group II falls to one at any point, a posting list may be moved from group I to group II. Additionally, if the total number of posting lists in both group I and group II combined falls below M, then the process may end, because there is no way for the constrained OR to be satisfied using the remaining elements.

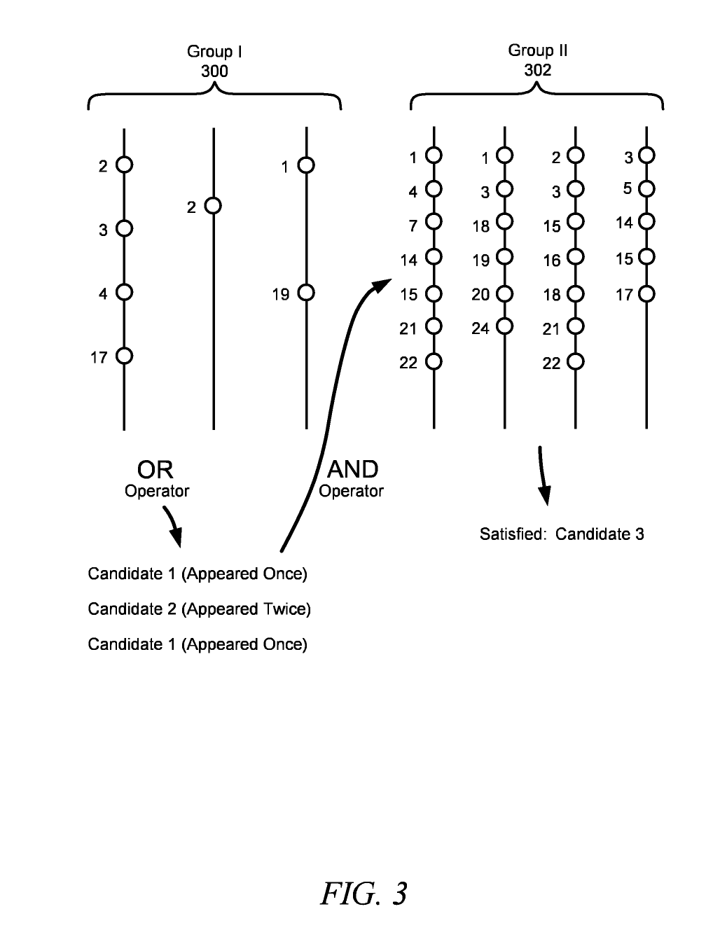

FIG. 3 is a diagram illustrating operation of a constrained OR operator in accordance with an example embodiment. In this example, there are seven arguments to the constrained OR operator (e.g., N=7), and M has been specified as 4. Thus, group I 300 contains four posting lists while group II 302 contains three posting lists. An OR operator is applied to group I 300, which results in a first candidate (“1”). It is determined that (“1”) only appears once in the group I 300, and thus there needs to be three matches in group II 302. An AND operator is applied to group II 302 for this candidate, and the system determines that this AND operation is not satisfied, and thus that “1” is not an element that satisfies the constrained OR operator.

Then the next candidate from the OR operator of group I 300 is examined (“2”), and it is determined that since “2” appeared twice in group I 300, there only needs to be two matches in group II 302. An AND operator is applied to group II 302 for this candidate, and the system determines that this AND operation is not satisfied, and thus that “2” is not an element that satisfies the constrained OR operator.

Then the next candidate from the OR operator of group I 300 is examined (“4”) and it is determined that since “4” appeared once in group I 300, there needs to be three matches in group II 302. An AND operator is applied to group II 302 for this candidate, and the system determines that this AND operation is satisfied, and thus that “3” is an element that satisfies the constrained OR operator.

This process continues until the end of one of the posting lists is reached. At that point the posting list is “dead” and removed, and the groups may be dynamically rearranged as described above. At that point, the process continues. This entire process repeats until only three posting lists remain, at which point the process may end.

In one example embodiment, the distribution of which arguments (and corresponding posting lists) are apportioned to which group is arbitrary and/or random. In another example embodiment, however, this apportionment may be performed in a smart manner. Specifically, some posting lists may be very sparse while others may be dense. This information may be used to place the most sparse posting lists in group I 300 and the most dense posting lists in group II 302, which further reduces the number of entities on which the OR operator needs to be applied.

It should be noted that there may be other example embodiments where the division between group I 300 and group II 302 may be varied from what is described above. For example, rather than group I 300 being N−M+1 and group II 302 being M−1, an implementation is foreseen where group I 300 is N−M+2 and group II 302 is M−2.

In an example embodiment, the OR operator may be modified so that rather than applying a next operation to the minimum element, the second most minimum element is found and the pointer to the minimum element is applied an advance operation to the next smallest minimum element.

### Suitable System

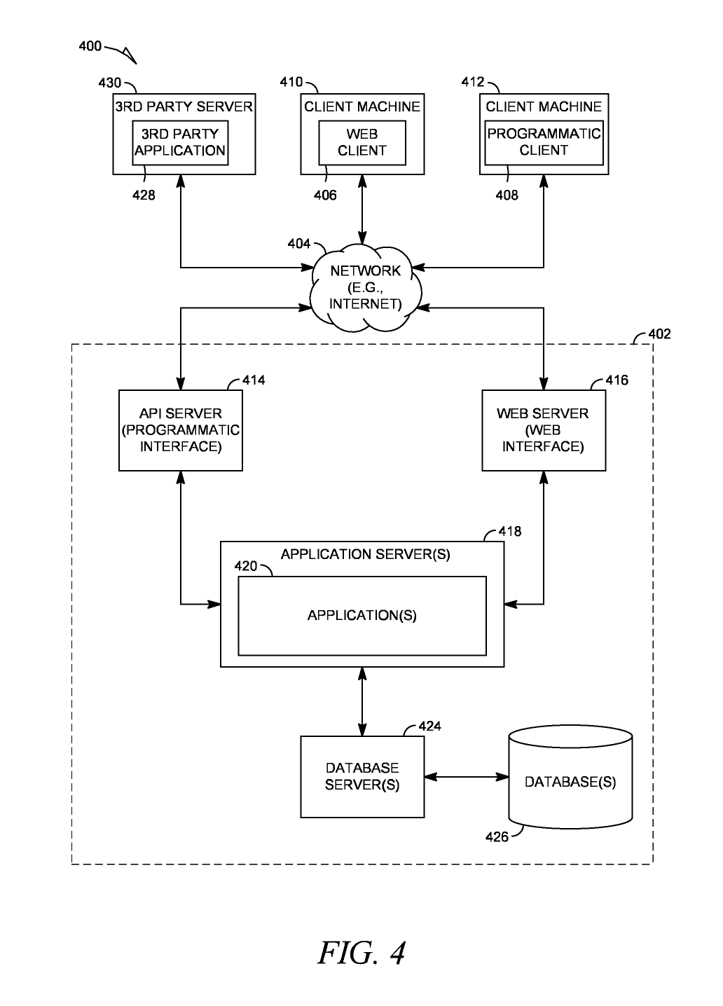

FIG. 4 is a network diagram depicting a client-server system 400, within which various example embodiments may be deployed. A networked system 402, in the example forms of a network-based social-networking site or other communication system, provides server-side functionality, via a network 404 (e.g., the Internet or Wide Area Network (WAN)) to one or more clients. FIG. 4 illustrates, for example, a web client 406 (e.g., a browser, such as the Internet Explorer browser developed by Microsoft Corporation of Redmond, Wash.) and a programmatic client 408 executing on respective client machines 410 and 412. Each of the one or more clients 406, 408 may include a software application module (e.g., a plug-in, add-in, or macro) that adds a specific service or feature to a larger system.

An API server 414 and a web server 416 are coupled to, and provide programmatic and web interfaces respectively to, one or more application servers 418. The application servers 418 host one or more applications 420. The application servers 418 are, in turn, shown to be coupled to one or more database server 424 that facilitates access to one or more NoSQL or non-relational data stores or database 426.

The applications 420 may provide a number of functions and services to users who access the networked system 402. While the applications 420 are shown in FIG. 4 to form part of the networked system 402, in alternative embodiments, the applications 420 may form part of a service that is separate and distinct from the networked system 402.

Further, while the system 400 shown in FIG. 4 employs a client-server architecture, various embodiments are, of course, not limited to such an architecture, and could equally well find application in a distributed, or peer-to-peer, architecture system, for example. The various applications 420 could also be implemented as standalone software programs, which do not necessarily have computer networking capabilities. Additionally, although FIG. 4 depicts third party server 430 and client machines 410 and 412 as being coupled to a single networked system 402, it will be readily apparent to one skilled in the art that third party server 430 and client machines 410 and 412, as well as third party application 428, web client 406, and programmatic client 408, may be coupled to multiple networked systems. For example, the third party application 428, web client 406, and programmatic client 408 may be coupled to multiple applications 420, such as payment applications associated with multiple payment processors (e.g., Visa, MasterCard, and American Express).

The web client 406 accesses the various applications 420 via the web interface supported by the web server 416. Similarly, the programmatic client 408 accesses the various services and functions provided by the applications 420 via the programmatic interface provided by the API server 414. The programmatic client 408 may, for example, perform batch-mode communications between the programmatic client 408 and the networked system 402.

FIG. 4 also illustrates a third party application 428, executing on a third party server machine 430, as having programmatic access to the networked system 402 via the programmatic interface provided by the API server 414. For example, the third party application 428 may, utilizing information retrieved from the networked system 402, support one or more features or functions on a website hosted by the third party. The third party website may, for example, provide one or more promotional, social-networking, or payment functions that are supported by the relevant applications of the networked system 402.

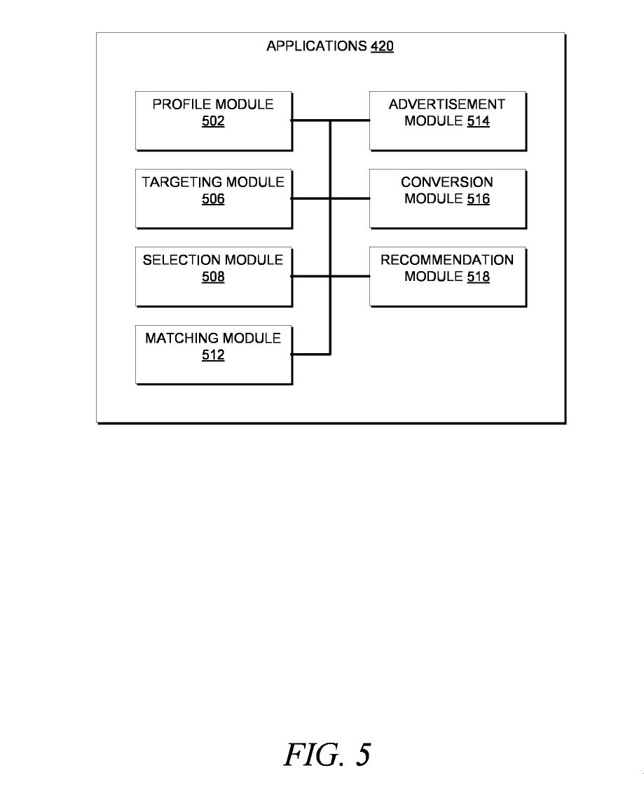

FIG. 5 is a block diagram illustrating example modules of the application(s) 420 of FIG. 4. A profile module 502 is configured to maintain or provide access to profiles of users of the system. A targeting module 506 is configured to receive a specification of information about users that advertisements are to target. A selection module 508 is configured to select one or more advertisements from a set of advertisements for presentation to a user (e.g., in advertising space on a content page that is to be presented to the user) or select one or more users from a set of users to which an advertisement is to be presented. A matching module 512 matches advertisements to users based on various criteria, such as an intersection between values of attributes of the users and advertisement target values. An advertisement module 514 is configured to place advertisements (e.g., in an advertising space) based on various criteria, such as a winning of an advertising auction for an advertising space or a purchasing of advertising space by an advertiser. A conversion module 516 is configured to determine a conversion rate of an advertisement based on various criteria, such as whether the advertisement was placed based on exact matching or a broad matching of a value of an attribute of a user to a target value associated with an advertisement. The conversion rate may be the rate at which users perform a desired action upon being presented with the advertisement in an advertising space on content pages presented to the users. For example, the conversion rate may be the rate at which users click on the advertisement to visit a web page associated with the advertiser who placed the advertisement. Or the conversion rate may be the rate at which users purchase a product on a web site associated with the advertiser. A recommendation module 518 is configured to make recommendations, such as a recommendation that an advertiser should increase a bid for an advertisement that uses a broad matching algorithm.

In an example embodiment, the features of the constrained OR operator as described herein are implemented in the matching module 512.

### Process Flow

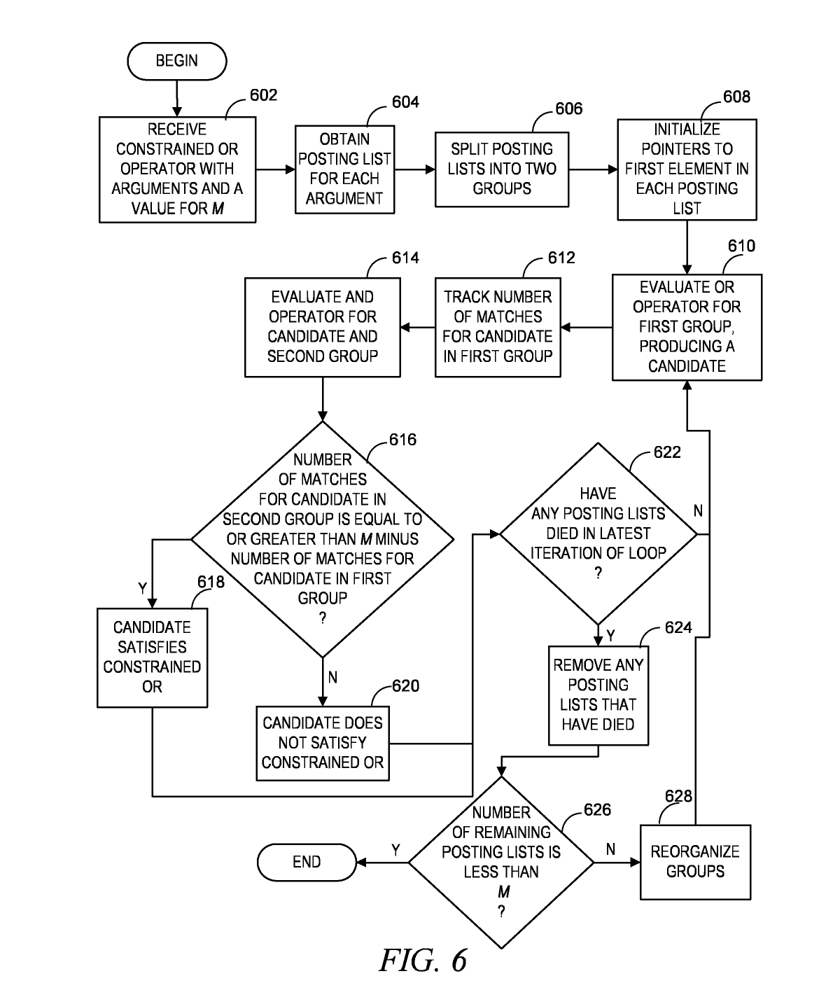

FIG. 6 is a flow diagram illustrating a method 600 for execution of a constrained OR operator in accordance with an example embodiment. At operation 602, the constrained OR operator with arguments and a value for M are received. At operation 604, a posting list for each argument is obtained. In an example embodiment, this may involve evaluating each argument against an inverted index to determine if a particular term in the argument is contained in an entry of the inverted index. The posting list may then be the list, for each argument, of all elements in the inverted index that satisfy the argument. In a further example embodiment, the inverted index is a mapping between terms and member identifications, the member identifications uniquely corresponding to member profiles on a social network.

At operation 606, the posting lists are split into two groups. In an example embodiment, the split occurs so that the first group contains N−M+1 posting lists while the second group contains M−1 posting lists, although this may vary based on implementation. In another example embodiment, the particular posting lists assigned to each group may be based on the sparsity of each posting list, with sparser posting lists assigned to the first group and denser posting lists assigned to the second group.

At operation 608, pointers for each posting list are initialized to point to the first element in each posting list. At operation 610, an OR operator is evaluated for the first group until a candidate is produced. At operation 612, the number of matches for the candidate in the first group is tracked. At operation 614, an AND operator is evaluated for the candidate and a second group. At operation 616, it is determined if the number of matches for the candidate in the second group is equal to or greater than M minus the number of matches for each candidate in the first group. If so, then at operation 618 it is determined that the candidate satisfies the constrained OR. If it is determined at operation 616 that the number of matches for the candidate in the second group is NOT equal to or greater than M minus the number of matches for each candidate in the first group, then at operation 620 it is determined that the candidate does not satisfy the constrained OR.

At operation 622, it is determined if any posting lists have dies in the latest iteration of the loop that began at operation 610. If not, then the loop is repeated, looking for an additional candidate to evaluate. If so, then at operation 624 any posting lists that have died are removed. At operation 626 it is determined if the number of posting lists remaining is less than M. If so, then the process is complete, and the result of the constrained OR operator is a listing of any candidate that satisfied the constrained OR. If not, then at operation 628 the groups may be reorganized. This may include moving one or more posting lists from one group to another. Then the loop is repeated at operation 610, looking for an additional candidate to evaluate.

It should be noted that in some example embodiments the value for M may change. In one example embodiment, different values for M may be assigned to different advertising campaigns. In another example embodiment, M may be set dynamically at runtime and even could be modified in the middle of the execution of a constrained OR operator.

### Example Mobile Device

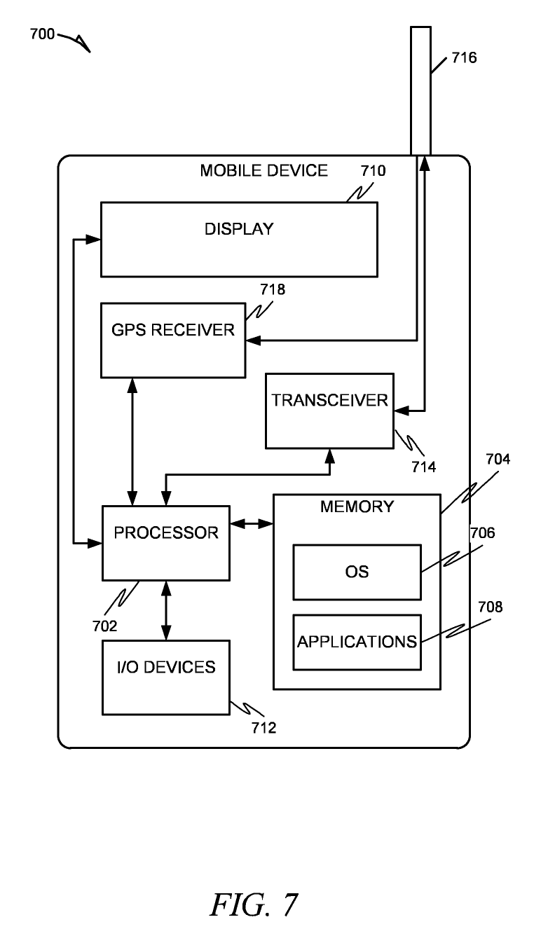

FIG. 7 is a block diagram illustrating a mobile device 700, according to an example embodiment. The mobile device 700 can include a processor 702. The processor 702 can be any of a variety of different types of commercially available processors 702 suitable for mobile devices 700 (for example, an XScale architecture microprocessor, a microprocessor without interlocked pipeline stages (MIPS) architecture processor, or another type of processor 702). A memory 704, such as a random access memory (RAM), a flash memory, or another type of memory, is typically accessible to the processor 702. The memory 704 can be adapted to store an operating system (OS) 706, as well as application programs 708. The processor 702 can be coupled, either directly or via appropriate intermediary hardware, to a display 710 and to one or more input/output (I/O) devices 712, such as a keypad, a touch panel sensor, a microphone, and the like. Similarly, in some embodiments, the processor 702 can be coupled to a transceiver 714 that interfaces with an antenna 716. The transceiver 714 can be configured to both transmit and receive cellular network signals, wireless data signals, or other types of signals via the antenna 716, depending on the nature of the mobile device 700. Further, in some configurations, a GPS receiver 718 can also make use of the antenna 716 to receive GPS signals.

### Modules, Components, and Logic

Certain embodiments are described herein as including logic or a number of components, modules, or mechanisms. Modules can constitute either software modules (e.g., code embodied (1) on a non-transitory machine-readable medium or (2) in a transmission signal) or hardware-implemented modules. A hardware-implemented module is a tangible unit capable of performing certain operations and can be configured or arranged in a certain manner. In example embodiments, one or more computer systems (e.g., a standalone, client, or server computer system) or one or more processors 702 can be configured by software (e.g., an application or application portion) as a hardware-implemented module that operates to perform certain operations as described herein.

In various embodiments, a hardware-implemented module can be implemented mechanically or electronically. For example, a hardware-implemented module can comprise dedicated circuitry or logic that is permanently configured (e.g., as a special-purpose processor, such as a field programmable gate array (FPGA) or an application-specific integrated circuit (ASIC)) to perform certain operations. A hardware-implemented module can also comprise programmable logic or circuitry (e.g., as encompassed within a general-purpose processor 702 or other programmable processor 702) that is temporarily configured by software to perform certain operations. It will be appreciated that the decision to implement a hardware-implemented module mechanically, in dedicated and permanently configured circuitry, or in temporarily configured circuitry (e.g., configured by software) can be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor 702 configured using software, the general-purpose processor 702 can be configured as different hardware-implemented modules at different times. Software can accordingly configure a processor 702, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules can be regarded as being communicatively coupled. Where multiple of such hardware-implemented modules exist contemporaneously, communications can be achieved through signal transmission (e.g., over appropriate circuits and buses that connect the hardware-implemented modules). In embodiments in which multiple hardware-implemented modules are configured or instantiated at different times, communications between such hardware-implemented modules can be achieved, for example, through the storage and retrieval of information in memory structures to which the multiple hardware-implemented modules have access. For example, one hardware-implemented module can perform an operation, and store the output of that operation in a memory device to which it is communicatively coupled. A further hardware-implemented module can then, at a later time, access the memory device to retrieve and process the stored output. Hardware-implemented modules can also initiate communications with input or output devices, and can operate on a resource (e.g., a collection of information).

The various operations of example methods described herein can be performed, at least partially, by one or more processors 702 that are temporarily configured (e.g., by software) or permanently configured to perform the relevant operations. Whether temporarily or permanently configured, such processors 702 can constitute processor-implemented modules that operate to perform one or more operations or functions. The modules referred to herein can, in some example embodiments, comprise processor-implemented modules.

Similarly, the methods described herein can be at least partially processor-implemented. For example, at least some of the operations of a method can be performed by one or more processors 702 or processor-implemented modules. The performance of certain of the operations can be distributed among the one or more processors 702, not only residing within a single machine, but deployed across a number of machines. In some example embodiments, the processor 702 or processors 702 can be located in a single location (e.g., within a home environment, an office environment, or a server farm), while in other embodiments, the processors 702 can be distributed across a number of locations.

The one or more processors 702 can also operate to support performance of the relevant operations in a “cloud computing” environment or as a “software as a service” (SaaS). For example, at least some of the operations can be performed by a group of computers (as examples of machines including processors 702), these operations being accessible via a network (e.g., the Internet) and via one or more appropriate interfaces (e.g., application program interfaces (APIs)).

### Electronic Apparatus and System

Example embodiments can be implemented in digital electronic circuitry, in computer hardware, firmware, or software, or in combinations of them. Example embodiments can be implemented using a computer program product, e.g., a computer program tangibly embodied in an information carrier, e.g., in a machine-readable medium for execution by, or to control the operation of, data processing apparatus, e.g., a programmable processor 702, a computer, or multiple computers.

A computer program can be written in any form of programming language, including compiled or interpreted languages, and it can be deployed in any form, including as a standalone program or as a module, subroutine, or other unit suitable for use in a computing environment. A computer program can be deployed to be executed on one computer or on multiple computers at one site or distributed across multiple sites and interconnected by a communication network.

In example embodiments, operations can be performed by one or more programmable processors 702 executing a computer program to perform functions by operating on input data and generating output. Method operations can also be performed by, and apparatus of example embodiments can be implemented as, special purpose logic circuitry, e.g., an FPGA or an ASIC.

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor 702), or in a combination of permanently and temporarily configured hardware can be a design choice. Below are set out hardware (e.g., machine) and software architectures that can be deployed, in various example embodiments.

### Example Machine Architecture and Machine-Readable Medium

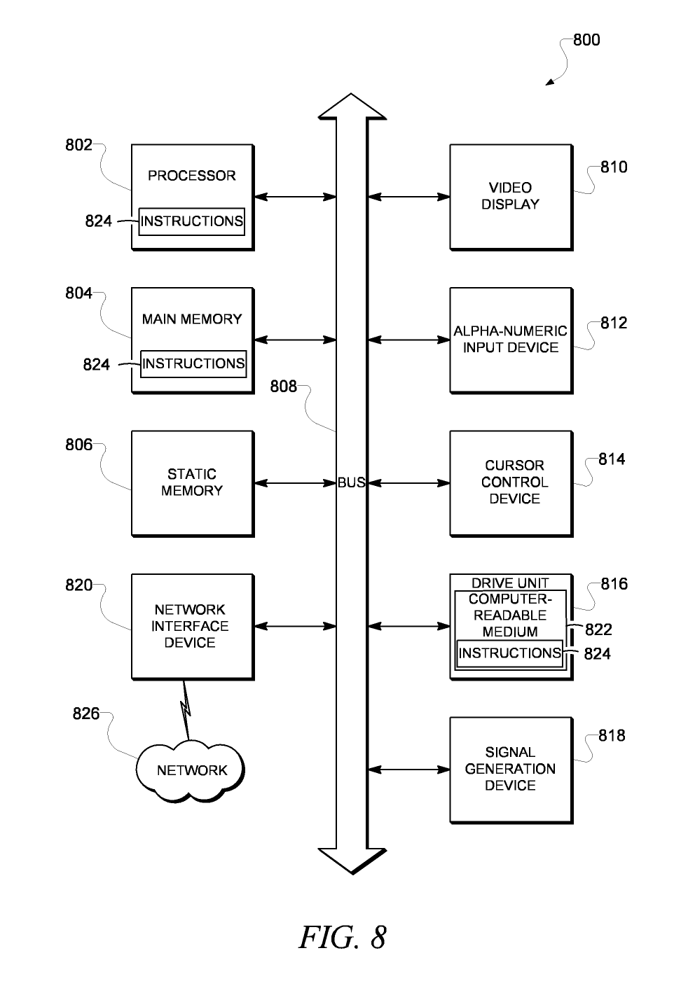

FIG. 8 is a block diagram of a machine in the example form of a computer system 800 within which instructions can be executed for causing the machine to perform any one or more of the methodologies discussed herein. In alternative embodiments, the machine operates as a standalone device or can be connected (e.g., networked) to other machines. In a networked deployment, the machine can operate in the capacity of a server or a client machine in server-client network environment, or as a peer machine in a peer-to-peer (or distributed) network environment. The machine can be a personal computer (PC), a tablet PC, a set-top box (STB), a personal digital assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 800 includes a processor 802 (e.g., a CPU, a graphics processing unit (GPU), or both), a main memory 804 and a static memory 806, which communicate with each other via a bus 808. The computer system 800 can further include a video display 810 (e.g., a liquid crystal display (LCD) or a cathode ray tube (CRT)). The computer system 800 also includes an alphanumeric input device 812 (e.g., a keyboard or a touch-sensitive display screen), a cursor control device 814 (e.g., a mouse), a drive unit 816, a signal generation device 818 (e.g., a speaker), and a network interface device 820.

### Machine-Readable Medium

The drive unit 816 includes a machine-readable medium 822 on which is stored one or more sets of instructions 824 (e.g., software) embodying or utilized by any one or more of the methodologies or functions described herein. The instructions 824 can also reside, completely or at least partially, within the main memory 804 and/or within the processor 802 during execution thereof by the computer system 800, the main memory 804 and the processor 802 also constituting machine-readable media 822.

While the machine-readable medium 822 is shown in an example embodiment to be a single medium, the term “machine-readable medium” can include a single medium or multiple media (e.g., a centralized or distributed database, and/or associated caches and servers) that store the one or more instructions 824 or data structures. The term “machine-readable medium” shall also be taken to include any tangible medium that is capable of storing, encoding, or carrying instructions 824 for execution by the machine and that cause the machine to perform any one or more of the methodologies of the present disclosure, or that is capable of storing, encoding, or carrying data structures utilized by or associated with such instructions 824. The term “machine-readable medium” shall accordingly be taken to include, but not be limited to, solid-state memories, and optical and magnetic media. Specific examples of machine-readable media 822 include non-volatile memory including, by way of example, semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and CD-ROM and DVD-ROM disks.

### Transmission Medium

The instructions 824 can further be transmitted or received over a communications network 826 using a transmission medium. The instructions 824 can be transmitted using the network interface device 820 and any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., WiFi and WiMax networks). The term “transmission medium” shall be taken to include any intangible medium that is capable of storing, encoding, or carrying instructions 824 for execution by the machine, and includes digital or analog communications signals or other intangible media to facilitate communication of such software.

Although an embodiment has been described with reference to specific example embodiments, it will be evident that various modifications and changes can be made to these embodiments without departing from the broader spirit and scope of the disclosure. Accordingly, the specification and drawings are to be regarded in an illustrative rather than a restrictive sense. The accompanying drawings that form a part hereof show by way of illustration, and not of limitation, specific embodiments in which the subject matter can be practiced. The embodiments illustrated are described in sufficient detail to enable those skilled in the art to practice the teachings disclosed herein. Other embodiments can be utilized and derived therefrom, such that structural and logical substitutions and changes can be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter can be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose can be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A computer-implemented method comprising:
receiving a constrained OR operator, the constrained OR operator including a plurality of arguments and a value M, M being an integer greater than 1 and less than a number of arguments in the plurality of arguments;
evaluating a set of data in a database based on each of the plurality of arguments, producing a plurality of posting lists corresponding to the arguments, each posting list containing a listing of data satisfying a corresponding argument;
determining data in the set of data that satisfies the constrained OR operator by obtaining an identification of each piece of data that is contained in at least M of the posting lists; and
returning identifications of each piece of data in the set of data that satisfies the constrained OR operator.

2. The method of claim 1, wherein the determining data includes:
splitting the posting lists into a first group of posting lists and a second group of posting lists;
evaluating an OR operator for the first group of posting lists, producing a candidate; and
evaluating an AND operator for the candidate and the second group of posting lists.

3. The method of claim 2, wherein the determining data further includes:
tracking a number of matches for the candidate in the first group of posting lists during the evaluation of the OR operator;
determining if a number of matches for the candidate in the second group of posting lists during the evaluation of the AND operator is equal to or greater than M minus the number of matches for the candidate in the first group of posting lists during the evaluation of the OR operator; and
in response to a determination that the number of matches for the candidate in the second group of posting lists during the evaluation of the AND operator is equal to or greater than M minus the number of matches for the candidate in the first group of posting lists during the evaluation of the OR operator, identifying the candidate as a piece of data in the set of data that satisfies the constrained OR operator.

4. The method of claim 3, wherein the determining data further includes repeating the evaluating the OR operator and the evaluating the AND operator until an end of at least one of the posting lists is reached.

5. The method of claim 4, wherein in response to the reaching of the end of a posting list, removing the posting list whose end has been reached from the corresponding group and repeating the evaluating the OR operator and the evaluating the AND operator.

6. The method of claim 5, further comprising reorganizing which posting list is in which group when a posting list is removed.

7. The method of claim 5, wherein the returning occurs after a determination that there are fewer than M posting lists left that have not been removed.

8. The method of claim 2, wherein the splitting the posting lists includes determining sparsity of each of the posting lists and placing sparser posting lists in the first group and denser posting lists in the second group.

9. An application server comprising:
a memory; and
one or more processors configured to:
receive a constrained OR operator, the constrained OR operator including a plurality of arguments and a value M, M being an integer greater than 1 and less than a number of arguments in the plurality of arguments;
evaluate a set of data in a database based on each of the plurality of arguments, producing a plurality of posting lists corresponding to the arguments, each posting list containing a listing of data satisfying a corresponding argument;
determine data in the set of data that satisfies the constrained OR operator by obtaining an identification of each piece of data that is contained in at least M of the posting lists; and
return identifications of each piece of data in the set of data that satisfies the constrained OR operator.

10. The application server of claim 9, wherein the determining data includes:
splitting the posting lists into a first group of posting lists and a second group of posting lists;
evaluating an OR operator for the first group of posting lists, producing a candidate; and
evaluating an AND operator for the candidate and the second group of posting lists.

11. The application server of claim 10, wherein the determining data further includes:
tracking a number of matches for the candidate in the first group of posting lists during the evaluation of the OR operator;
determining if a number of matches for the candidate in the second group of posting lists during the evaluation of the AND operator is equal to or greater than M minus the number of matches for the candidate in the first group of posting lists during the evaluation of the OR operator; and
in response to a determination that the number of matches for the candidate in the second group of posting lists during the evaluation of the AND operator is equal to or greater than M minus the number of matches for the candidate in the first group of posting lists during the evaluation of the OR operator, identifying the candidate as a piece of data in the set of data that satisfies the constrained OR operator.

12. The application server of claim 9, wherein the data is member profiles and the identifications are member identifications.

13. The application server of claim 12, wherein each of the arguments evaluates member profiles to determine if they meet a criteria set for the corresponding argument.

14. The application server of claim 13, wherein the matching module is triggered by a user performing an action upon which an advertisement could be served and the matching module is further configured to serve a particular advertisement on each member corresponding to the member identifications returned.

15. A non-transitory machine-readable storage medium having instruction data to cause a machine to perform the following operations:
receiving a constrained OR operator, the constrained OR operator including a plurality of arguments and a value M, M being an integer greater than 1 and less than a number of arguments in the plurality of arguments;
evaluating a set of data in a database based on each of the plurality of arguments, producing a plurality of posting lists corresponding to the arguments, each posting list containing a listing of data satisfying a corresponding argument;
determining data in the set of data that satisfies the constrained OR operator by obtaining an identification of each piece of data that is contained in at least M of the posting lists; and
returning identifications of each piece of data in the set of data that satisfies the constrained OR operator.

16. The non-transitory machine-readable storage medium of claim 15, wherein the determining data includes:
splitting the posting lists into a first group of posting lists and a second group of posting lists;
evaluating an OR operator for the first group of posting lists, producing a candidate; and
evaluating an AND operator for the candidate and the second group of posting lists.

17. The non-transitory machine-readable storage medium of claim 16, wherein the determining data further includes:
tracking a number of matches for the candidate in the first group of posting lists during the evaluation of the OR operator;
determining if a number of matches for the candidate in the second group of posting lists during the evaluation of the AND operator is equal to or greater than M minus the number of matches for the candidate in the first group of posting lists during the evaluation of the OR operator; and
in response to a determination that the number of matches for the candidate in the second group of posting lists during the evaluation of the AND operator is equal to or greater than M minus the number of matches for the candidate in the first group of posting lists during the evaluation of the OR operator, identifying the candidate as a piece of data in the set of data that satisfies the constrained OR operator.

18. The non-transitory machine-readable storage medium of claim 17, wherein the determining data further includes repeating the evaluating the OR operator and the evaluating the AND operator until an end of at least one of the posting lists is reached.

19. The non-transitory machine-readable storage medium of claim 18, wherein in response to the reaching of the end of a posting list, removing the posting list whose end has been reached from the corresponding group and repeating the evaluating the OR operator and the evaluating the AND operator.

20. The non-transitory machine-readable storage medium of claim 19, further comprising reorganizing which posting list is in which group when a posting list is removed.
